(19) United States
(12) Patent Application Publication
(10) Pub. No.: US 2009/0311483 A1
(43) Pub. Date: Dec. 17, 2009

(54) Articles with Two Crystalline Materials and Method of Making Same

(75) Inventors: Wayne D. Kaplan, Kiryat-Tivon (IL); Yaron Kauffmann, Haifa (IL)

Correspondence Address: MARTIN D. MOYNIHAN d/b/a PRTSI, INC., P.O. BOX 16446, ARLINGTON, VA, 22215, US

(73) Assignee: Technion Research & Development Foundation Ltd., Haifa (IL)

(21) Appl. No.: 12/225,879

(22) PCT Filed: Apr. 10, 2007
(86) PCT No.: PCT/IL2007/000459

§ 371 Date: Aug. 12, 2009

Related U.S. Application Data
(60) Provisional application No. 60/788,705, filed on Apr. 4, 2006.

(51) Int. Cl. B32B 3/00; C23F 1/00; C25D 5/00

(52) U.S. Cl. 428/172; 216/39; 205/209

(57) ABSTRACT

Articles having a first substance, naturally having a first crystalline structure, confined between surfaces of a second substance having a second crystalline structure, whereby the first substance has a third (unusual) crystalline structure different from said first crystalline structure and methods of making same. Substances having unusual crystalline structures and methods of making same.

### FIELD AND BACKGROUND OF THE INVENTION

The present invention relates to epitaxial growth of one crystal on the surface of another, with small number of defects in the interface between the crystals. The present invention further relates to substances having unusual crystalline structures and methods of making same.

Modern electrical devices are manufactured by VLSI techniques (Very Large Scale Integration), integrating a very large number of different electrical component on a single chip. Some such elements may be, for instance, MOSFETs (Metal Oxide Semiconductor Field Effect Transistors) FinFETs (Fin Field Effect Transistors) and others.

Many, if not all of these components include contacts between different crystalline substances. Such contacts many times have defects, because of mismatch between the crystalline structures of the two different substances. These defects slow down the operation of the electronic components, and in some cases prevent the use of certain couples of materials.

Optical components, such as optical switches, suffer from a similar defect problem, where defects between two contacting crystalline substances slow down the operation of the optical component, and in some cases prevent the use of certain couples of materials.

In both cases it is desired in order to overcome the problem that neighboring crystals of different substances (materials) contacting one another shall have similar or identical crystalline structures, which is known in the art as heteroepitaxy. However, different substances typically have different crystalline structures.

It is also desired to produce new substances characterized by novel crystalline structures and which may have properties different from those characterizing their known crystalline structures.

The present invention seeks to cope with the defect problem and the above desires using insight gained from an article published in Science, Vol. 310 Pages 661-663, providing evidence for ordering of liquid atoms adjacent to an interface with a crystal.

### SUMMARY OF THE INVENTION

A broad aspect of some embodiments of the invention concerns contacting two crystalline materials with a small number of defects in the interface between them. In an exemplary embodiment of the invention this is achieved by letting a liquid of one material solidify within a nanometric groove made in another. The ordering of the liquid near the surface of the groove allows solidification to occur with only a small number of defects, and in some embodiments, with no defects at all.

A small number of defects is defined as the number which do not adversely affect the properties of the device. This number is smaller by at least 20%, optionally by at least 50%, optionally by at least 80% than the number of defects obtained by current PVD or CVD technology, whichever provides fewer defects in the specific system. The defects can be counted by preparing transmission electron microscopy (TEM) samples in cross-section of the interface, and using diffraction contrast or phase contrast to detect and count the linear density of defects. This is a standard method, which is expanded upon in the textbook: David. B. Williams and C. Barry Carter, Transmission Electron Microscopy, Plenum Press, New York, 1996, pages 403-420, and 441-455.

Another broad aspect of some embodiments of the invention, concerns unusual crystal structures that crystalline substances may acquire when they are crystallized confined between surfaces of another crystalline substance. Such unusual and novel crystal structures may find use in new nano-electronic materials with new qualities. As the electronic and the optical properties of most materials, including semiconductors, are controlled by the crystalline structure of the material, having materials in new crystal structures will allow device designers to use known materials in new ways. For example, silicon exists only in a cubic structure. Solidifying silicon into a hexagonal structure may provide a material having different electronic properties, e.g. band structure and band gap.

In accordance with an exemplary embodiment of the invention, there is provided an article, comprising a first crystalline substance confining within it tiny amounts of a second crystalline substance, with a relatively small number of defects at the interface between the two crystalline substances. Optionally or characteristically, the crystalline structure of the second, confined, crystalline substance is different from the crystalline structure of the same substance when it is not confined.

The first crystalline substance will be termed herein a “confining substance” and the second crystalline substance will be termed herein a “confined substance”.

In an embodiment of the invention, the confined substance is confined within confining structures. An example to a confining structure is a groove. Optionally, a groove has a cross-section with a shape of a triangle (i.e., V-shaped), square, or any other polygonal shape with one side open. The shape of the groove is generally straight or angled, but not curved.

In an embodiment of the invention, the confined substance solidifies in the groove, and the ordering effect that the groove's surface has on the liquid confined substance, helps obtaining an interface with a small number of defects.

In embodiments of the invention, the crystalline structure of the confining substance is bestowed on the confined substance when the confined substance solidifies near a surface of a crystal of the confining substance. This surface is named herein crystallization surface. As the crystallization surface is smaller relative to the volume of the groove, bestowing the crystalline structure becomes less probable.

Therefore, according to exemplary embodiments of the invention, at least one dimension of the confining structure, optionally two or three dimensions thereof, is (are) at most 20 nm in length. The minimal length of the at least one dimension is determined by the specific substances, but is usually not smaller than 1 nm.

An aspect of some embodiments of the invention concerns methods of obtaining a crystalline substance confined within another crystalline substance, with a small number of defects between them, optionally, with the confining substance bestowing its crystalline structure on the confined one.

An aspect of some embodiments of the invention concerns methods of making a confined substance with a small number of defects in the interface between the confined substance and the confining substance. Optionally, the confined substance is obtained in an unusual crystalline structure. In an embodiment of the invention, a crystalline substrate made of the confining substance is grooved, atoms of the confined substance are deposited on the grooved substrate, and then heated to melt. The melt flows into the grooves, and then is slowly cooled to crystallize inside the grooves. Preferably, the melting point of the confined substance is lower than that of the confining substance, such that when the confined substance is melted, the confining substance remains solid and does not loose its crystalline structure.

In an embodiment of the invention, the flow of the melt into the grooves is facilitated by using a substrate coated with a coating that repels the liquid of the confined substance, or at least attracts it less than does the confining substance. The coated substrate is grooved with grooves going from the coating into the crystalline substrate.

In an embodiment of the invention, after the grooves are made, and before the confined substance is deposited, it is beneficial to heat the confining substance as to allow the newly formed walls of the grooves to equilibrate and thus expose crystalline facets. In some embodiments, the heating used for liquefying the confined substance is sufficient also for equilibrating the groove walls and such intermediate heating may be omitted.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 is a schematic illustration of an article according to an embodiment of the invention;

FIG. 2A is a schematic illustration of a grooved substrate, showing atoms of the substrate;

FIG. 2B is a schematic illustration of a crystal structure;

FIG. 2C is a schematic illustration of a grooved substrate with a solid in the groove and defects between the groove surfaces and the solid;

FIG. 2D is a schematic illustration of a grooved substrate with a solid in the groove and with no defects between the groove surfaces and the solid;

FIG. 3A is a schematic illustration of an article according to an embodiment of the invention,

FIGS. 3B1-3B3 schematically illustrate patterns grooves may have according to embodiments of the present invention;

FIG. 4 is a schematic illustration of an article according to an embodiment of the invention;

FIG. 5 is a flow chart of a method of making an article according to an embodiment of the invention; and

FIG. 6 is a schematic illustration of a coated substrate, form which an article according to the invention may be made.

### DETAILED DESCRIPTION OF EXEMPLARY EMBODIMENTS

The present invention is of articles of manufacturing having a first substance, naturally having a first crystalline structure, confined between surfaces of a second substance having a second crystalline structure, whereby the first substance has a third (unusual) crystalline structure different from said first crystalline structure and to methods of making same. The present invention further relates to substances having unusual crystalline structures and methods of making same. The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

### Overview

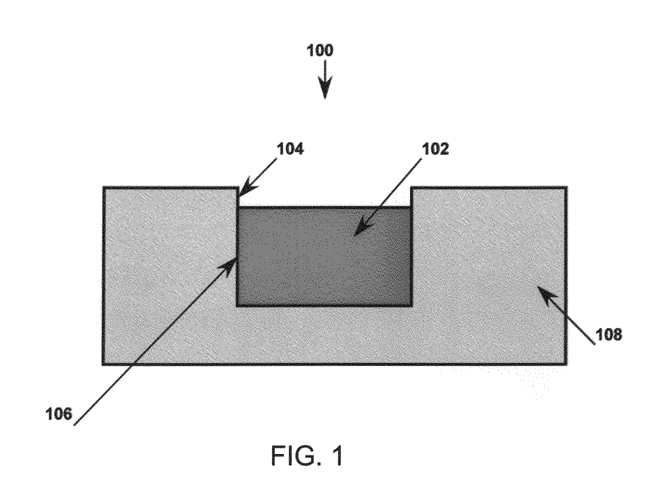

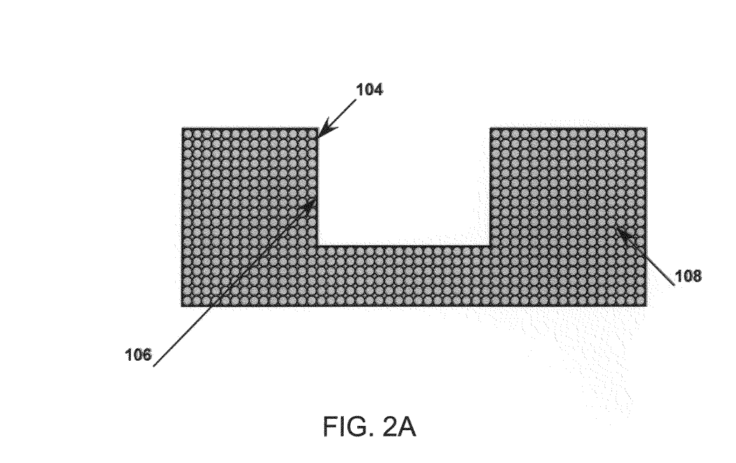

FIG. 1 is a schematic illustration of an article of manufacturing 100 according to an embodiment of the present invention. Article 100 comprises a first substance 102, confined between surfaces 104 of grooves 106 made in a second substance 108.

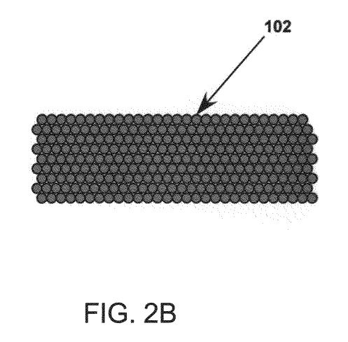

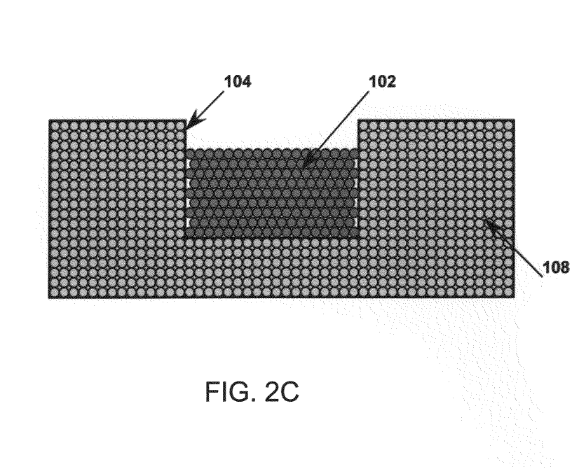

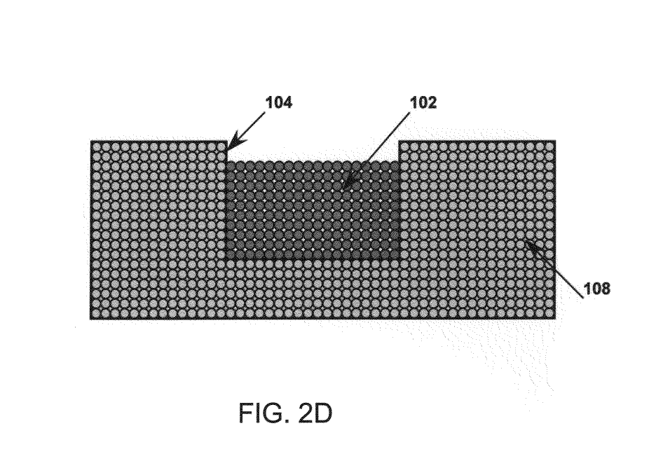

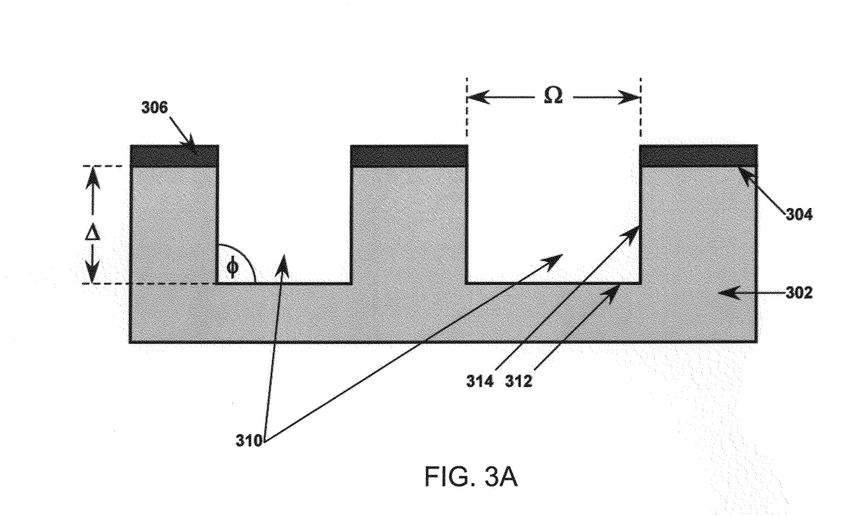

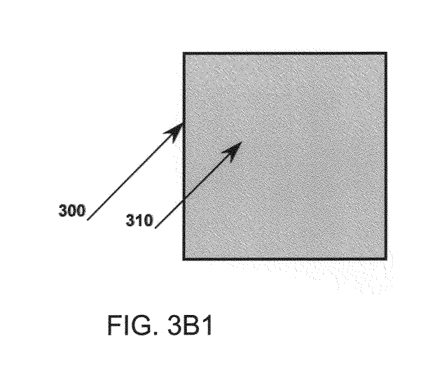

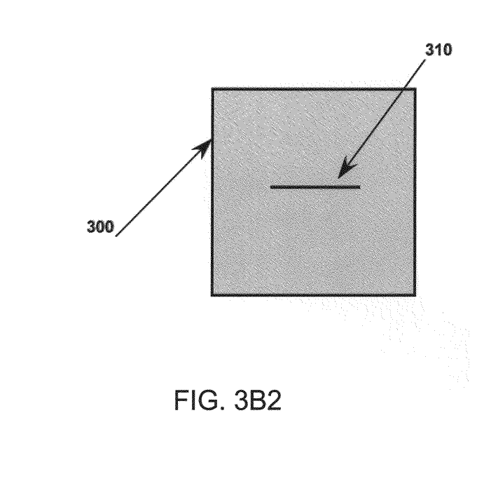

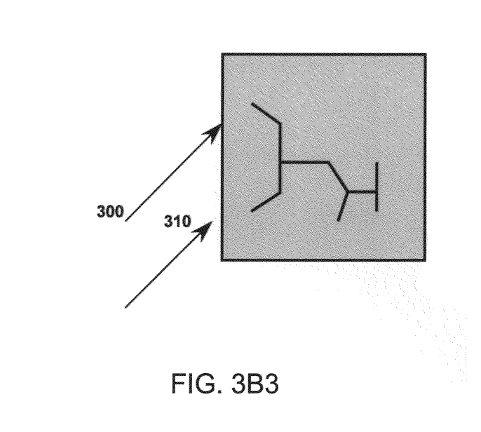

FIG. 2A schematically and simplistically illustrates a substrate 200, having a groove 202 and comprising a first, confining, substance (204), having a first crystalline structure. FIG. 2B schematically illustrates crystalline structure of a second substance, when not so confined. FIG. 2C illustrates the second substance 208 when confined within groove 202 in a manner that creates many of defects 210. FIG. 2D schematically illustrates the same grooved substance with the same second substance, after melting of the second substance and slow cooling according to an embodiment of the invention. While in the embodiment illustrated in FIG. 3D the crystal structure of the confined material is exactly the same as that of the confining substance, in other embodiments, the correspondence between the crystal structures of the two substances is only partial. For instance, there may be a full correspondence between the structure of the adjacent layers, but deeper inside the confined substance, the crystal structure may be different than deeper inside the confining substance. Alternatively or additionally, the structures of the adjacent layers do not fully correspond, and yet, the number of defects is small.

FIG. 2E illustrates defects obtained in the prior art in a contact between two crystalline materials, due to mismatch between crystal structures of the two materials.

FIG. 2A is a schematic illustration of a crystalline structure substance 108 optionally has.

FIG. 2B is a schematic illustration of the crystalline structure substance 102 optionally has when it is not confined between surfaces 104.

FIG. 2C is a schematic illustration of a crystalline structure of substance 102 when confined between surfaces 104, in accordance with an embodiment of the invention. The crystalline structure of the confined substance 102 is different from the naturally occurring crystalline structure of the same substance, depicted in FIG. 2B, and different from the crystalline structure of substance 108 depicted in FIG. 2A.

FIG. 2D is a schematic illustration of a crystalline structure of substance 102 when confined between surfaces 104, in accordance with another embodiment of the invention. Here, the crystalline structure of the confining substance is bestowed on the confined substance.

It should be noted that one substance may naturally occur in several different crystalline structures, usually called in the art “polymorphs”. Usually, each polymorph is known to be stable under some well defined conditions of pressure and temperature.

In some embodiments of the invention, a confined substance appears in a crystalline structure which the same substance, when not confined, is known to have under different conditions. In some embodiments of the invention, a confined substance appears in a crystalline structure which the same substance, when not confined, is not known to have under any conditions. In some embodiments of the invention, a confined substance appears in the crystalline structure characterizing the substance confining it, thus forming heteroepitaxy.

The exact crystalline structure obtained in practice in a particular embodiment may be detected, for instance, by TEM, and can be manipulated by controlling the manner in which the article of manufacture is made, for instance, the rate at which the confined substance is cooled to solidify, and by choosing suitable substances. For instance, substances with more similar naturally occurring crystalline structures are more probable to have exactly the same, heteroepitaxial, crystalline structure in accordance with embodiments of the invention, than are substances with less similar naturally occurring crystalline structure.

### An Exemplary Article

FIG. 3A is a schematic illustration of an article of manufacturing 300 according to an embodiment of the invention. Article 300 comprises a crystalline substrate 302 having a surface 304, and a coating 306 coating surface 304.

Article 300 has grooves 310. Each of grooves 310 has a bottom 312 and side walls 314 meeting bottom 312 at an angle φ. Angle φ is optionally 90° as in the figure. Optionally, in some embodiments the angle is different, and the base of the groove is larger or smaller than its entrance at the upper surface. Preferably, the bottom-wall meeting is angled, and not curved.

Grooves 310 follow a predetermined pattern, as schematically illustrated in FIGS. 3B1-3B3. More generally, grooves 310 are formed in coating 306 and into substrate 302. Width Ω and depth Δ are each is from about 1 nm to about 20 nm, optionally from about 5 to about 15 nm.

Substrate 302 is a substrate of a different material substance than the coating 306, and the coating is selected such that its interface energy with the liquid is higher than the interface energy between the liquid and the substrate, so as to facilitate penetration of a liquid into grooves 310. Thickness of coating 306 is optionally between 2 and 5 nm. The difference in interface energies is typically of the order of at least 10% at the melting point of the liquid. Relative values of interface energies can be measured by sessile drop experiments.

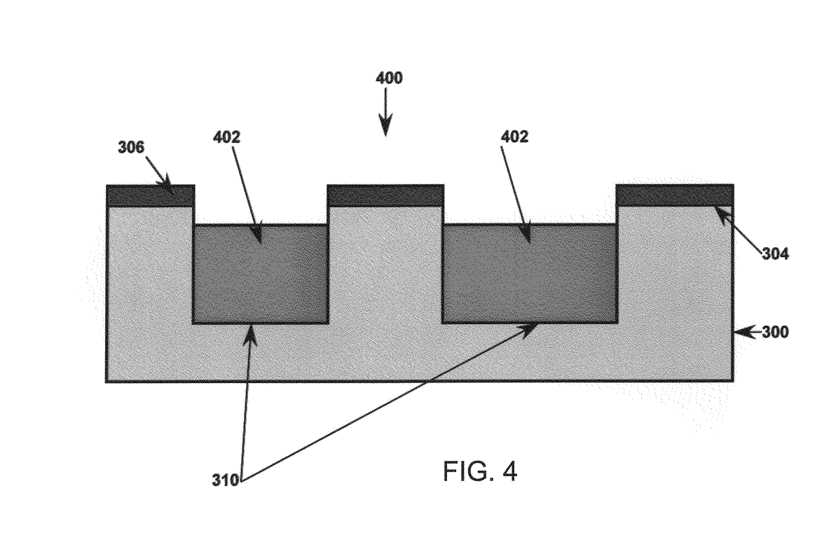

FIG. 4 shows an article 400 comprising article 300 with a low-melting substance 402 inside grooves 310. Low-melting substance 402 has a melting point lower than that of substrate 302 and lower than that of coating 306. Typical values of meting points of substance 402 in various embodiments of the invention are between about 500K and about 2100K. Substance 402 is shown in a solid state. As explained in the context of FIGS. 2A-2D, substance 402 has a crystalline structure different from the crystalline structure the same substance has when not confined within grooves 310.

### An Exemplary Making Method

### Preparing an Article Ready to Receive a Confined Substance

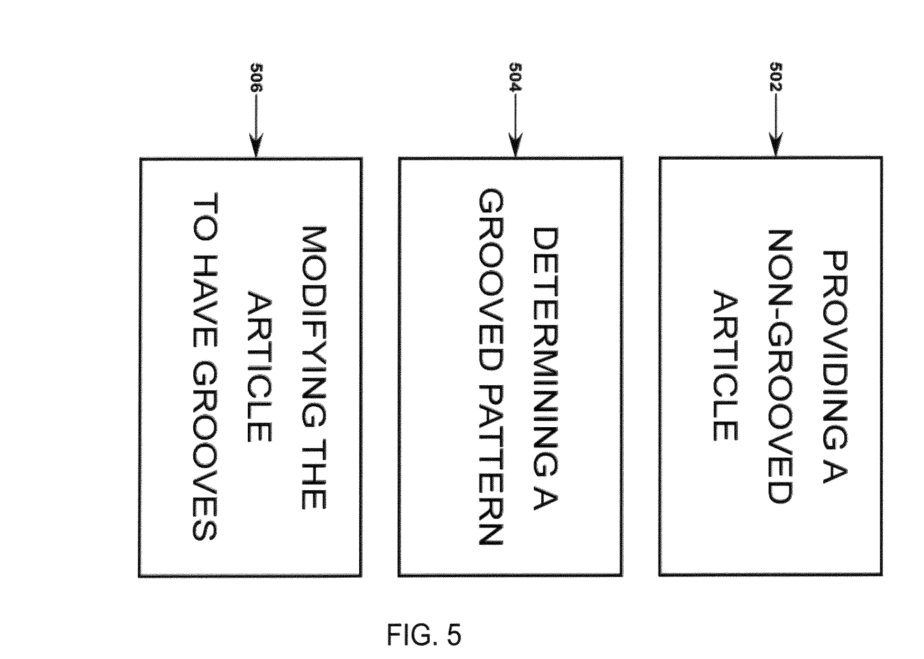

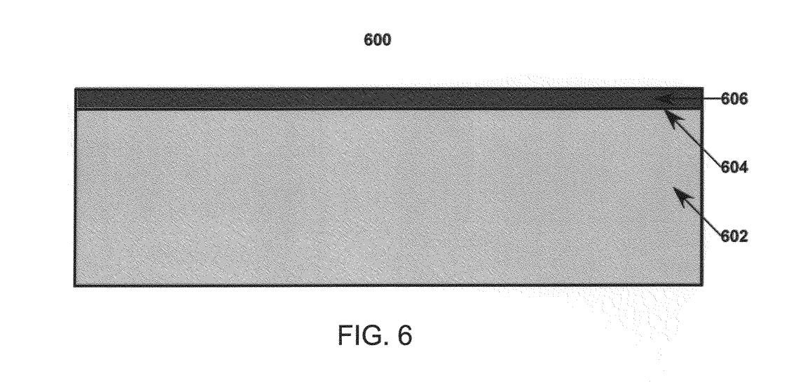

FIG. 5 is a flowchart showing actions, to be performed in a method 500 of manufacturing a grooved article 300 according to an exemplary embodiment of the invention. FIG. 6 schematically illustrates a non grooved article, from which an article as depicted in FIG. 3A or FIG. 4 is manufactured in accordance with an embodiment of the present invention.

Method 500 includes In a first step, providing (502) a non-grooved article (600, FIG. 6); In a subsequent step, determining (504) a pattern of grooves to be made on the non-grooved article (an exemplary pattern is illustrated in FIG. 1B); and in a subsequent step, modifying (506) article 600 to have grooves 310 along the determined pattern. Article 600 is shown to include a crystalline substrate 602, having a surface 604 and a coating 606 coating surface 604. In some embodiments of the invention, modifying the article to have grooves is done by grooving into the article, for instance by focused ion beam etching. In this method, a focused beam of high energy incident ions is rastered across the surface of the substrate, resulting in sputtering of substrate atoms out of the substrate, leaving behind a void. When the beam crosses a site, from which substrate atoms are not to be sputtered, it is blanked. The size and shape of the void depend on the rastering pattern and ion beam flux of the incident ion beam. In some embodiments of the invention, modifying the article to have grooves is done by building the grooves on the outer surface of the article, for instance, by Electron Beam Lithography (EBL). In EBL, portions of the substrate are covered with an electron photoresist material, such as polymethyl methacrylate (PMMA). The covered substrate is then exposed to a rastered electron beam, in a pattern which is pre-set by the designer. After exposure to the electron beam, the exposed resist is dissolved, leaving behind a pattern of residual resist and voids in the resist which reach into the substrate. In an alternative EBL method, the electron beam modifies the masking substance so that it is not dissolved after exposure (negative versus positive resist materials). After EBL a different material is deposited, for instance using physical vapor deposition (PVD), which adheres only on the places where the resist material was dissolved, and thus is in contact with the substrate. This process forms grooves (or other geometric shapes), which can then serve as the groove walls as defined herein. In some embodiments of the invention, the grooves do not show crystalline facets. To expose crystalline facets it may be beneficial to heat the article, thus speeding its equilibration. Such heating is usually termed in the field as “annealing”. In exemplary embodiments of the invention, the annealing temperature is between about 70% and about 90% of the temperature at which the crystalline substance of substrate 602 melts. All temperatures mentioned herein are measured on an absolute scale, i.e., the Kelvin scale, unless otherwise is explicitly mentioned. Heating to less than 70% of the melting point might result in slow equilibration, and thus slowing the process of preparing article 400. Heating to more than 90% of the melting temperature might start a melting process in substrate 602, and thus introduce defects into its crystalline structure. The heating is optionally for a period of between about 5 minutes to about an hour. As for heating rate, it is preferable to heat to the annealing temperature at a rate that does not create a temperature shock in the substances, of which the article is formed. In exemplary embodiments of the invention, suitable heating rates are between about 1° K per minute and about 5° K per minute.

### Introducing the Confined Substance

In an embodiment of the invention, when a grooved article 300 is ready for use, a lower-melting substance is deposited thereon, melted to flow into grooves 310, and cooled to solidify so as to obtain article 400.

The low-melting substance has a melting temperature that is lower by at least 20% of that of the substrate substance and, if present, from that of the coating, such that melting the low-melting substance does not melt the substrate and/or the coating and does not introduce defects into the crystalline structure of the crystalline substrate.

Depositing the low melting substance can be done, optionally by physical vapor deposition, chemical vapor deposition, electrochemical deposition, or any other deposition method known in the field.

After deposition, the low-melting substance is heated to about 105% to about 115%, for instance, about 110%, of its melting temperature to obtain the low-melting substance in a liquid state. In some embodiments of the invention, this heating is also co-functional to anneal the inner surfaces of grooves 310, rendering the annealing step mentioned above under the heading “Preparing an article ready to receive a confined substance” superfluous.

In some embodiments of the invention, the deposition itself is carried out at high enough a temperature, such that the deposited low-melt substance is deposited in liquid state, and further heating after deposition is not required.

The liquid low-melt substance flows into the grooves. This flow is driven by the natural tendency of a liquid to occupy the entire surface provided to it. Nevertheless, in many cases the liquid fails to fill the grooves, but rather creates drops that cover the grooves so as to close them from their open side. To facilitate liquid flow into the grooves, it may be beneficial to have the coating 406 made of a substance that repels the liquid, or at least attracts it to a lesser extent than does the crystalline substance of the substrate. In some embodiments of the invention, the liquid is more attracted to the crystalline facets exposed within the grooves than to the crystalline outer surface of the substrate. In such a case, or in any other case that the liquid willingly flows into the grooves from the outer surface of the substrate, a non-coated substrate may be used instead of coated substrate 600.

### Cooling the Low-Melt Substance

In exemplary embodiments of the invention, after the liquid of the low-melt substance is in the grooves, it is cooled to solidify. The cooling is preferably slow enough to prevent thermal shock. Exemplary cooling rates are between about 1° K per minute and 8° K per minute, optionally between 2° K and 4° K per minute.

When the low-melt material solidifies in the grooves, the article is optionally cleaned from leftovers of solid low-melt material left on the outer surface of the article. This may be done by any method known in the art, for instance, chemical mechanical polishing.

### Suitable Substances

The above description spelled out the main requirements from substances to be a confining substance, a confined substance, and, where required, a coating substance. Non-limiting examples of suitable liquids include conductors, preferably metals, such as copper, gold, tin, and/or aluminum. Non-limiting examples of suitable substrate materials are semi-conductors, such as Si, GaN, and GaAs. Non-limiting examples to suitable coatings are oxides, like, for example, SiO₂ and Al₂O₃, optionally in the form of sapphire; and nitrides, like, for example, AlN, GaN, Si₃N₄, BN, TiN, TaN, and HfN.

Specified below are some substrate-coating-liquid systems suitable for use in accordance with various embodiments of the present invention. In all the specified examples, SiO₂ may be suitable as a coating material. Another example of a substrate material may be α-Al₂O₃, where the coating may be, for instance, AlN and the liquid-silicon.

Non-limiting examples of suitable confining materials are Si, α-Al₂O₃ (sapphire), and GaN.

Non-limiting examples of suitable confined substances are: Pb, Cu, Au, Al, Ge, Ga, and In, all of which may be confined within a silicon substrate. Additional examples are silicon and Ge which may be confined in sapphire or GaN.

As used herein throughout the term about shall mean +/−10%.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1-55. (canceled)

56. An article of manufacturing comprising:
(a) a crystalline substrate having a surface;
(b) a coating covering at least a portion of said surface;
the article of manufacturing having grooves following a predetermined pattern, the grooves being formed in said coating and into said substrate, said grooves having a width at said substrate surface of 20 nm or less and a depth into said substrate of 20 nm or less,
wherein the substrate is made of a substrate substance having a substrate surface energy and the coating is made of a coating substance having a coating surface energy, and the coating surface energy is different from the substrate surface energy so as to facilitate penetration of a liquid into said grooves.

57. An article according to claim 56, wherein the atoms of the substrate material at the groove surfaces are in thermal equilibrium.

58. An article according to claim 56, wherein each of the grooves has a bottom and side walls meeting said bottom at an angle.

59. An article according to claim 56, having a low-melting material inside the grooves, said low-melting material having a melting point lower than a melting point of the substrate substance and lower than the melting point of the coating substance.

60. An article according to claim 59, wherein the melting point of the low-melting material is between 500K and 2100K.

61. An article according to claim 59, wherein said low-melting material is in solid state.

62. An article according to claim 61, wherein said low-melting material in solid state has a crystalline structure.

63. An article according to claim 61, wherein the crystalline structure of the low-melting material is the same as the crystalline structure of the substrate.

64. A method of manufacturing a grooved article of manufacture, the method comprising:
(a) providing an article of manufacturing comprising:
(i) a crystalline substrate having a surface and being made of a substrate substance having a substrate surface energy;
(ii) a coating covering at least a portion of said surface and being made of a coating substance having a coating surface energy different from the substrate surface energy so as to facilitate penetration of a liquid into grooves in said substance;
(b) determining a pattern; and
(c) modifying the provided article of manufacturing to have grooves along said pattern, said grooves having a width at said substrate interface of 20 nm or less and a depth into said substrate of 20 nm or less.

65. A method according to claim 64, wherein said modifying comprises etching.

66. A method according to claim 64, wherein said modifying comprises Electron Beam Lithography.

67. A method according to claim 64, comprising heating the grooved article to an annealing temperature lower than a melting point of the substrate material.

68. A method according to claim 67, wherein said annealing temperature is between 70% and 90% of the melting point of the substrate material, measured on an absolute scale.

69. A method according claim 67, wherein said heating comprises heating at a rate of between 1 and 5 K per minute.

70. A method according to claim 64, comprising depositing a low-melting material on the grooved article, said low-melting material having a melting temperature lower that the melting temperature of the substrate and lower than the melting temperature of the coating.

71. A method according to claim 70, wherein said depositing comprises physical vapor deposition (PVD).

72. A method according to claim 70, wherein said depositing comprises chemical vapor deposition (CVD).

73. A method according to claim 70, wherein said depositing comprises electrochemical deposition.

74. A method according to claim 70, comprising removing from the coating low-melting material deposited out of said grooves.

75. A method according to any of claims 70, wherein depositing is at a temperature higher than the melting temperature of the liquid material, and the method comprises cooling the liquid to obtain in the grooves liquid material in solid state.

76. A method according to claim 75, wherein said cooling comprises cooling at a rate of between 1 and 5 K per minute.
